(19) United States
(12) Patent Application Publication
(10) Pub. No.: US 2007/0041599 A1
(43) Pub. Date: Feb. 22, 2007

(54) Quickly Installed Multiple Speaker Surround Sound System and Method

(76) Inventors: Lloyd M. Gauthier, Houston, TX (US); Nancy M. Gauthier, Houston, TX (US)

Correspondence Address: KENNETH L. NASH, P.O. BOX 680106, HOUSTON, TX, 77268-0106, US

(21) Appl. No.: 11/427,397

(22) Filed: Jun. 29, 2006

Related U.S. Application Data
(63) Continuation of application No. 29/210,120, filed on Jul. 27, 2004, now abandoned.

(51) Int. Cl. H04R 5/02

(52) U.S. Cl. 381/307

(57) ABSTRACT

A surround sound speaker system is provided whereby multiple speakers that broadcast acoustic signals representative of sound from different directions may be mounted in one speaker housing rather than in separate speaker housings that are positioned at separate positions within the room. Thus, the present invention eliminates the need to mount and run wiring to separate speakers in the room. Because the number of speakers within the speaker housing can be relatively easily increased, the surround sound speaker system can be utilized to implement even highly complicated surround sound systems such as surround sound system 9.1, which is otherwise very difficult and expensive for the average consumer to install or have installed.

This application claims the benefit of U.S. patent application Ser. No. 29/210,120 filed Jul. 27, 2004.

### BACKGROUND OF THE INVENTION

1. Field of the Invention

The present invention relates generally to multiple speaker surround sound systems and, more particularly, to a system and methods for providing that even the most advanced and complicated surround sound systems having large numbers of speakers may be quickly installed.

2. Description of the Background

Despite the cost and wiring and mounting problems and lack of wall space that homeowners typically have, the home entertainment market yearns for the experience felt in movie theatres. It would be desirable to provide an easily and quickly mountable speaker system that will allow consumers to relatively quickly install and enjoy even the latest surround sound capabilities, while conserving space, reducing setup time, and all without losing functionality.

Commercially available surround sound systems are becoming increasingly complicated. Some surround sound standards are fairly common, such as the 5.1 surround sound system perfected by Dolby® digital technologies, wherein five separate electronic signals are utilized with at least five speakers that surround the listener with realistic sound from at least five directions. Usually, this has meant three speakers in front of the listener and two behind the listener. More recent sound system standards include the 7.1 surround sound mode wherein seven speakers are utilized to express seven electronically different sound channels, besides base speakers. Currently, there is a stereo receiver that supports up to nine surround sound speakers (9.1 surround sound). However, the difficulties of providing such a complicated system as the 9.1 surround sound system has thus far limited consumer interest, as well as the speaker manufacturers' current inability to provide such a speaker system.

Those who have installed these systems realize that considerable time and cost is involved in mounting the 5.1 system, which requires five different cables or channels for speakers, and mounting the speakers at appropriate positions in the room. Wall space for consumers is often limited thereby making placement of the speakers problematic. It is especially costly to avoid clutter and still provide a system that is serviceable if connection problems arise. The cost and possibility of connection problems increase dramatically as the systems and wiring become ever more complicated. To connect and mount speakers to provide surround sound in multiple rooms is especially difficult.

Consequently, there remains a long felt need for improved systems and methods for consumer surround sound systems. Because those skilled in the art have recognized and attempted to solve these problems in the past, they will appreciate the present invention which addresses these and other problems.

### SUMMARY OF THE INVENTION

It is an object of the present invention to provide an improved surround sound system and method.

It is another object of the present invention to provide a surround sound system for 5.1 surround sound that may be almost as quickly installed as the much more complicated 9.1 surround sound system.

It is yet another object of the present invention to provide a surround sound system in a package form so convenient that it can be used in different rooms, wherein the majority of sound channels may be implemented using a single speaker housing.

It is yet another object of the present invention to provide an improved system wherein acoustic feedback may be used for automatically adjusting the sound system for a desired frequency response.

It is yet another object of the present invention to provide an improved system that may or may not require running speaker wires.

It is another object of the present invention to provide a centrally located speaker cluster that directs sound radially outwardly to produce sound reflections for creating surround sound for use with all standardized surround sound formats.

These and other objects, features, and advantages of the present invention will become apparent from the drawings, the descriptions given herein, and the appended claims. However, it will be understood that the above-listed objectives and/or advantages of the invention are intended only as an aid in quickly understanding aspects of the invention, are not intended to limit the invention in any way, and therefore do not form a comprehensive or restrictive list of objectives, and/or features, and/or advantages.

Accordingly, the present invention provides a method for installing a standardized surround sound system within a room, the standardized sound system producing a plurality of channels of acoustic output wherein each channel is representative of acoustic sound from a different direction for an anticipated listener. The plurality of channels comprise at least a front center channel, a front left side channel, a front right side channel, a rear left channel, and a rear right channel.

The method may preferably comprise mounting a speaker housing in a central position of the room. In a preferred embodiment, the speaker housing may comprise a plurality of speakers mounted within the speaker housing wherein, respective of the plurality of speakers, produce the plurality of channels of acoustic output. The plurality of speakers are preferably oriented such that an acoustic output therefrom is directed radially outwardly away from the housing and the central position of the room toward walls of the room. Thus, acoustic output produced by the plurality of speakers may originate at the central position of the room and then reflect from the walls of the room back to the central position of the room. To implement the plurality of channels of acoustic output, the speaker housing may comprise at least a front center speaker, a front left side speaker, a front right side speaker, a rear left speaker, and a rear right speaker. In one preferred embodiment, the plurality of speakers are each less than about three inches in diameter thereby permitting the speaker housing to be compact. When mounting the speaker housing, the front center speaker is oriented to direct acoustic output therefrom toward a front center position of the room, the front left side speaker being oriented to direct acoustic output therefrom toward the front left side of the room, a front right side speaker to direct acoustic output therefrom toward a front right side of the room, the rear left speaker being oriented to direct acoustic output therefrom toward a rear left of the room, and the rear right speaker being oriented to direct acoustic output therefrom towards a right rear of the room.

The method may further comprise mounting the speaker housing to a ceiling. In this case, the speaker housing may comprise at least one additional speaker at a lower portion thereof and oriented directly downwardly to the central position of the room.

An acoustic insulator layer may comprise at least one hole therein to receive the at least one additional speaker. The acoustic insulator layer dampens acoustic output in a downward direction when the speaker housing is mounted to the ceiling. The plurality of speakers may be mounted adjacent to or at a periphery of speaker housing such that acoustic output from the speakers directly downwardly is dampened by the acoustic insulator layer. If the plurality of speakers are mounted inside an outer perimeter of the acoustic insulator layer, then acoustic output produced by the plurality of speakers around the periphery will travel without interruption outwardly, thereby reflecting against walls of the room back to the central position of the room.

The method may further comprise running a single wiring harness between an amplifier and the speaker housing, the single wiring harness comprising speaker wires for the plurality of speakers which represent all of the plurality of channels, so that the wiring need only go to one location rather than throughout the room.

In another embodiment, the method may further comprise electromagnetically transmitting the surround sound channel signals for the plurality of speakers to an electronic wireless receiver positioned within the speaker housing. In this case, the speaker wires effectively connect the electronic wireless receiver to corresponding of each of the plurality of speakers.

In one possible embodiment for the ceiling mount option, the method may further comprise providing ceiling lights within the speaker housing. In another embodiment, the method may further comprise mounting the speaker housing within a table or on a stand.

In another embodiment, the method may further comprise a computer controlled acoustic equalizer to produce a desired acoustic response at the central position of the room by utilizing a directed acoustic sensor positioned at the central position, whereby the directed acoustic sensor is operable for determining a strength and direction of acoustic signals produced by the speaker housing.

In another embodiment, the present invention comprises a speaker system to implement a standardized surround sound system. In accord with the present invention, the surround sound speaker system may be largely implemented utilizing a single speaker housing. In one embodiment, the base speaker(s) may be positioned elsewhere in the room.

### BRIEF DESCRIPTION OF THE DRAWINGS

FIG. 1 is a cross-sectional view of a speaker housing wherein speakers used to implement a plurality of surround sound channels are mounted within a single housing in accord with one possible embodiment of the present invention;

FIG. 2 is a bottom view, with internal components shown in dash, of the speaker housing of FIG. 1;

FIG. 3 is a side perspective view of a speaker housing to implement a plurality of surround sound channels within a single housing in accord with one possible embodiment of the present invention;

FIG. 4 is a side elevational view of a speaker housing intended to be mounted to the ceiling of a room to implement a plurality of surround sound channels within a single housing in accord with one possible embodiment of the present invention;

FIG. 5 is a side elevational view of a speaker housing intended to be built into furniture such as a table to thereby implement a plurality of surround sound channels within a single housing in accord with one possible embodiment of the present invention;

FIG. 6 is an enlarged side elevational view, in cross-section, of a speaker housing showing an acoustic dampening layer above and below the speakers in accord with one possible embodiment of the present invention;

FIG. 7 is a schematic block diagram of selected components of a surround sound system in accord with the present invention;

FIG. 8 is a schematic of a stand-mounted speaker housing to implement a plurality of surround sound channels within a single housing in accord with one possible embodiment of the present invention;

FIG. 9 is an elevational side view schematic of a room, which indicates acoustic signal output of a speaker housing within the room that directs the channels outwardly against the walls and reflects back toward the user in accord with one possible embodiment of the present invention;

FIG. 10 is a schematic view looking down from the ceiling, which shows the acoustic output being directed radially outwardly from the speaker housing in accord with one possible embodiment of the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention and as defined in the appended claims.

### DESCRIPTION OF PRESENTLY PREFERRED EMBODIMENTS

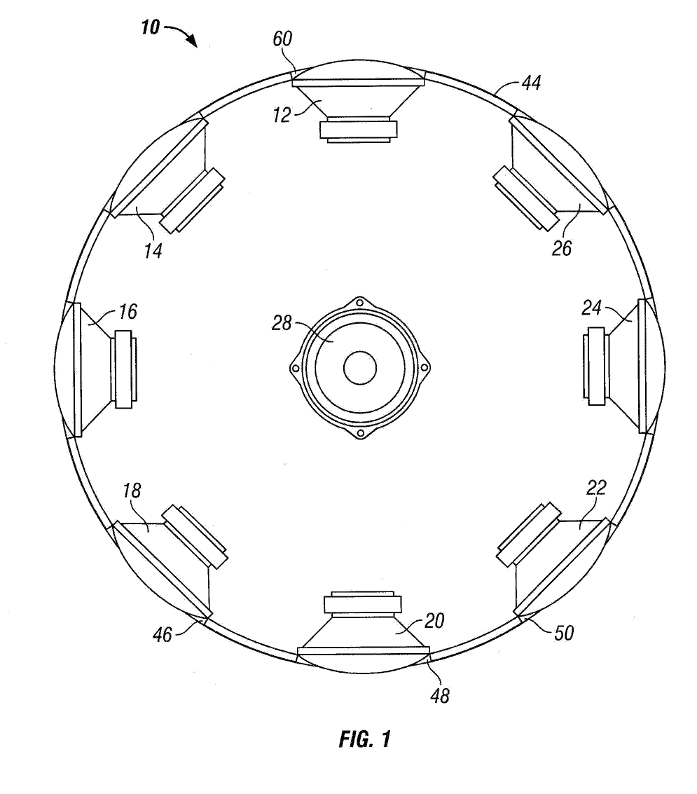

Referring now to the figures, and more particularly to FIG. 1, there is shown an interior of speaker housing 10 in accord with one possible embodiment of the present invention. The speakers produce a respective channel of sound from the surround sound electronics. Each surround sound channel is directional in the sense that each channel produces sound which would come from a particular direction with respect to a listener in a room. A huge advantage of the present invention is that it allows virtually all the speakers for the surround sound system to be placed into a single speaker housing 10. In the prior art, it is necessary to mount different speakers in different parts of the room and connect those speakers to the surround sound electronics. The more surround sound channels there are, the more speakers are required. The more speakers there are, the more time consuming, expensive, and cluttered the installation. Moreover, wall space may be limited if the room has other furniture in it. For this reason, the more advanced formats of the surround sound system are not normally utilized by consumers. In contrast, FIG. 1 illustrates the simplicity of speaker layout for what would normally be quite a complicated 9.1 surround sound system in accord with the present invention.

In the embodiment of the present invention, as shown in FIG. 1, speaker 12 is the front center speaker which may correspond to a front center surround sound channel. Speaker 14 is the front left speaker which may correspond to a front left surround sound channel. Likewise, speaker 16 is the left side speaker; speaker 18 is the rear surround left speaker; speaker 20 is the rear surround center speaker; speaker 22 is the rear surround right speaker; speaker 24 is the right side speaker; and speaker 26 is the front right speaker. In one possible embodiment, a central speaker 28 may be used as discussed hereinafter.

In one preferred embodiment, the speakers are relatively small and may be less than about three inches in diameter. In this way, speaker housing 10 is quite lightweight. Small speakers also result in a relatively small diameter of speaker housing 10 for easier handling. In one preferred embodiment, speaker housing 10 may be less than about two feet in diameter. Modern small speakers are often used to create excellent sound. While the advantage of small speakers is clear, the present invention could also be implemented with larger speakers.

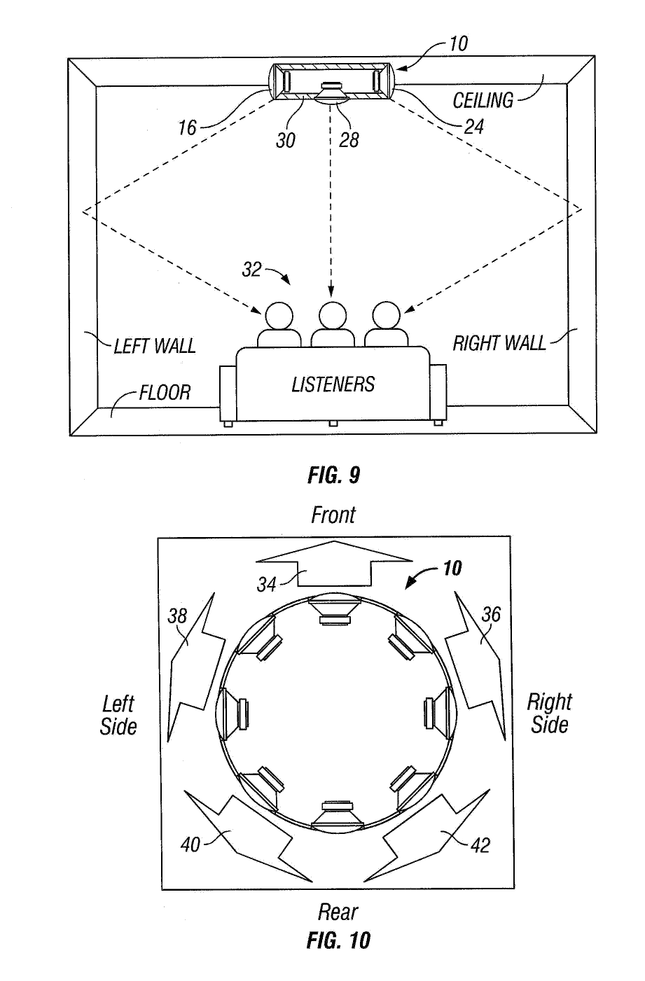

FIGS. 9 and 10 provide an overview of the principal of operation of the system in accord with one possible embodiment. Other construction detail of speaker housing 10 to implement the principal of operation is provided hereinafter.

In FIG. 9, speaker housing 10 is mounted to the ceiling of a room as illustrated. Speaker housing 10 is shown in cross-section where left side speaker 16 and right side speaker 24 are shown to illustrate one of the principles of operation of the present invention. The operation of the other peripherally mounted speakers is similar and so are not shown.

Acoustic output from left side speaker 16 is directed radially outwardly from speaker housing 10 due to the construction of speaker housing 10 discussed hereinafter and due to the fact that speaker housing 10 is oriented so that left side speaker 16 is pointing to the wall of the room. Thus, acoustic output from left side speaker is directed radially outwardly until it encounters the left wall of the room whereupon the acoustic energy is reflected back to a central portion 32 of the room wherein listeners are anticipated to be positioned. An acoustic sound barrier 30 absorbs, reflects, and/or blocks downwardly directed acoustic output from the peripherally mounted speakers such as speaker 16. Sound barrier 30 may comprise suitable materials for absorbing, reflecting, and/or blocking the acoustic signal. Likewise, speaker housing 10 is oriented so that right side speaker 24 directs acoustic output to the right wall as shown. The other peripherally mounted speakers also effectively radiate acoustic output radially outwardly. Sound absorption or barrier layer 30 prevents the acoustic output from going directly to the listeners. Speaker housing 10 preferably has speaker openings such as openings 46, 48, and 50 in peripheral wall 44, shown in FIG. 1, for respective speakers 18, 20, and 22. The openings provide that the acoustic signal can easily be transmitted radially outwardly from speaker housing 10.

If desired, central or enhanced supplemental center speaker 28 may also be utilized. Supplemental center speaker 28 can aid in special effects and may be used in certain listening modes. As well, to the extent that the surround sound system may produce a sound channel that comes from above the listeners, speaker 28 can fill this requirement.

FIG. 10 shows the general operation of speaker housing 10 for a 5.1 surround sound system. For instance, a front center speaker such as speaker 12 may be used to direct acoustic signal directly towards the front of the room as indicated by arrow 34. Likewise, the front right speakers and the front left speakers may direct front right and front left sound channels as indicated by arrows 36 and 38. The rear channels may be directed to the rear left and rear right as indicated by arrows 40 and 42.

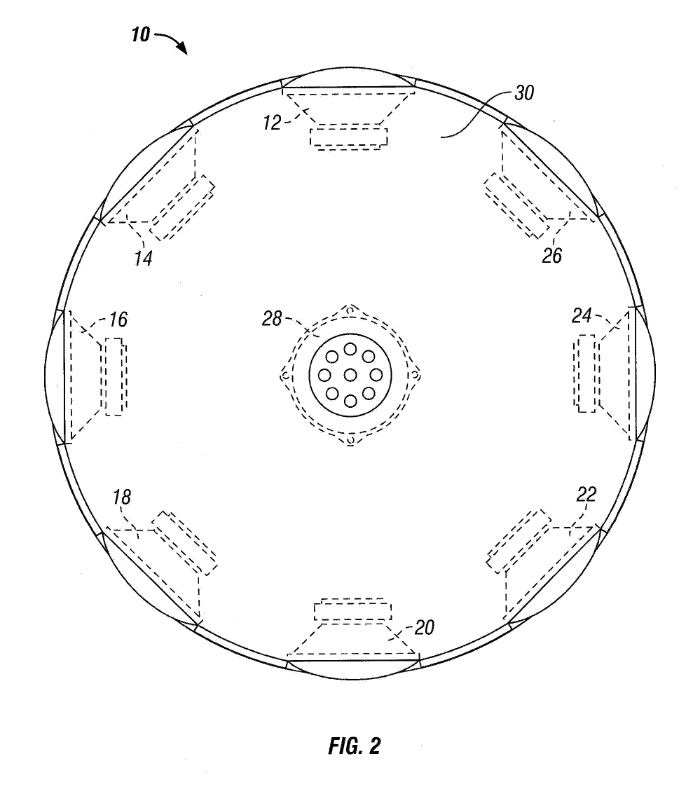

FIG. 2 shows speaker housing 10 with the speakers mounted internally and illustrated in dash. As discussed above, a hole in sound barrier 30 may be provided in speaker housing 10 for central speaker 28. However, even though acoustic signal from speaker 28 can be directed directly downward to the listener or central portion of the room, lower sound insulation layer 30 will effectively block the acoustic signals from peripheral speakers 12, 14, 16, 18, 20, 22, 24, and 26. As discussed earlier, the sound or acoustic output is directed radially outwardly from speaker housing 10.

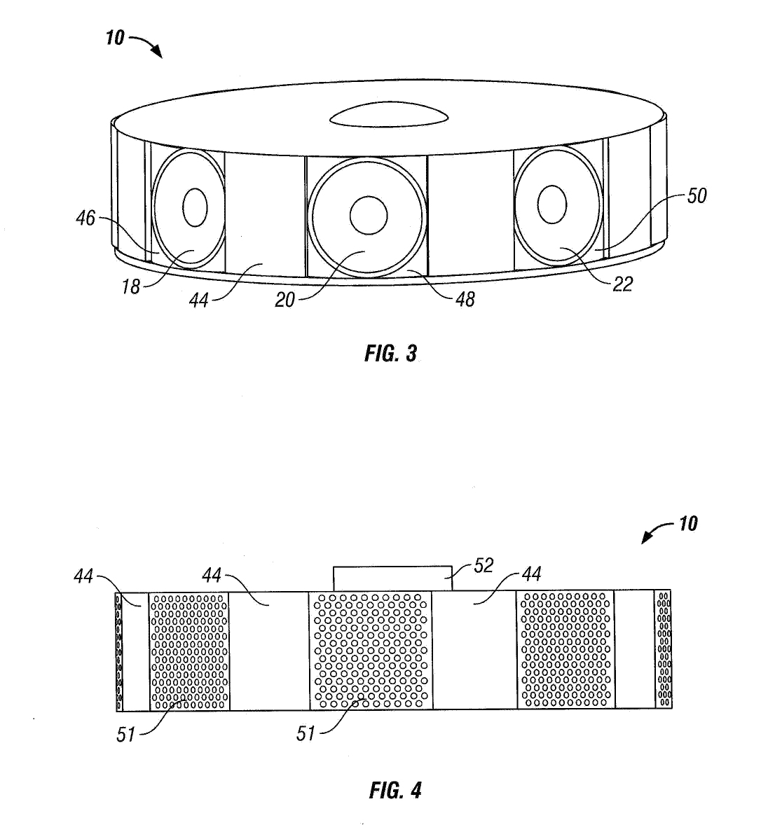

A perspective view of speaker housing 10 is shown in FIG. 3 where peripheral speakers 18, 20, and 22 are mounted around the periphery of speaker housing 10. Speaker housing 10 may be round or polygonal in shape. In FIG. 4, speaker housing 10 is shown with acoustic material 51, such as grills that cover the speaker openings, but allow the acoustic output to easily pass through. Thus, radial wall 44 of speaker housing 10 has openings formed therein for receiving the various speakers. For instance, openings 46, 48, and 50 permit speakers 18, 20, and 22 to direct acoustic output radially outwardly from speaker housing 10. Wall 44 also provides acoustic dampening, absorption, and/or blocking to better direct the acoustic output in preferred radial directions corresponding to the surround sound channels as illustrated in FIG. 10. Thus, wall 44 provides greater directivity of sound produced using speaker housing 10.

FIG. 4 also shows a ceiling mount embodiment of speaker housing 10. A central connector 52 may be utilized to secure speaker housing 10 to the ceiling. The central connector 52 may also be utilized to guide wires into speaker housing 10. Of course, other types of connectors could also be used in addition to central connector 52 in order to secure speaker housing 10 to the ceiling of a room.

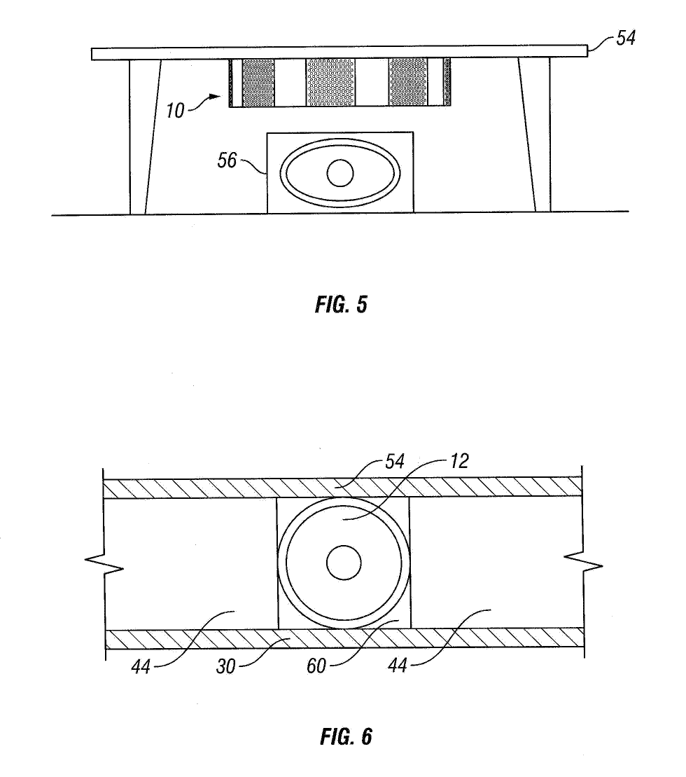

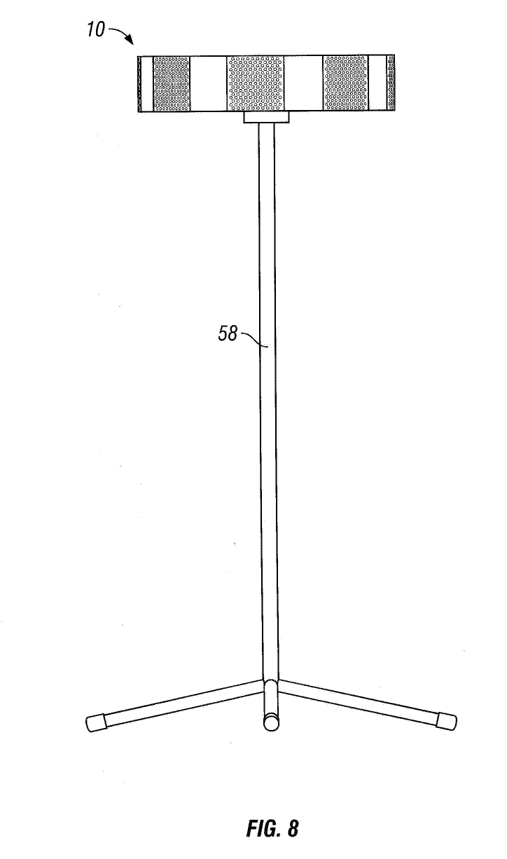

FIG. 5 shows another embodiment of the present invention where speaker housing 10 may be used or incorporated into furniture such as into table 54. It will also be appreciated that base speaker 56 may be mounted separately from speaker housing 10 because lower frequency sounds are often considered non-directional. In another embodiment as shown in FIG. 8, stand 58 may be utilized to mount speaker housing 10 close to the ceiling.

In FIG. 6, an enlarged version is shown which illustrates upper and lower acoustic barrier layers 30 and 54. As discussed previously, acoustic barrier layers may comprise dampening, reflecting, and /or acoustic blocking material. Acoustic barrier layer 30 prevents or reduces the amount of acoustic output being directed downwardly towards the listener. Likewise, acoustic barrier layer 54 prevents sound from being directed upwardly. One or both of these acoustic barrier layers may be present in speaker housing 10. It would be desirable that for the ceiling mount version, that at least acoustic barrier layer 30 be provided. For the table round embodiment of the invention shown in FIG. 5, it would be desirable that at least upper acoustic barrier layer 54 be included within speaker housing 10. However, if desired, both upper and lower acoustic dampening layers 54 and 30 respectively may be included within speaker housing 10. As discussed previously, walls 44 are also acoustic barriers which cause speaker acoustic output to be directed only through openings in wall 44, e.g., opening 60 shown in FIG. 6 for speaker 12. This improves the radial directivity of speaker housing 10 for more separate surround sound channels.

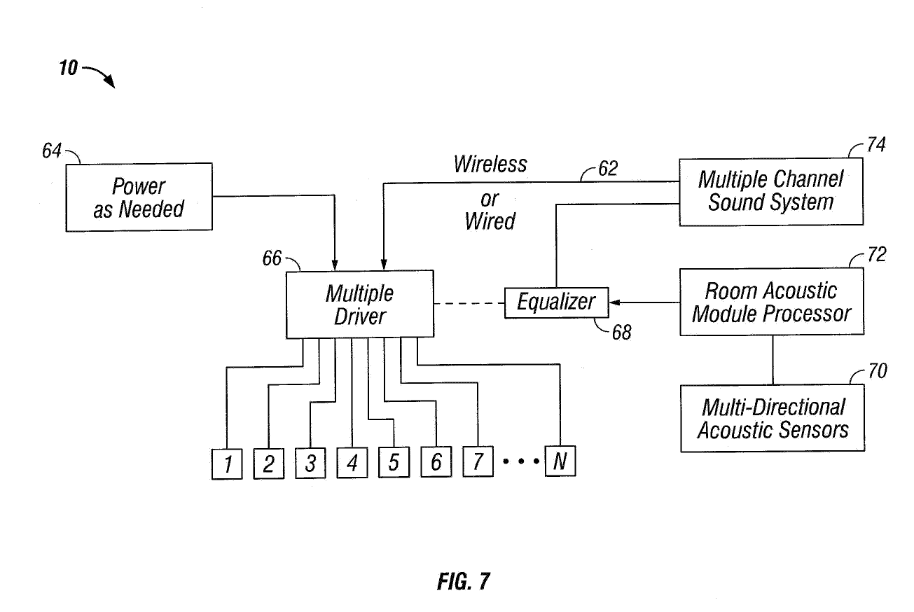

In FIG. 7, an electronic schematic is shown which includes various features of a surround sound system. Acoustic signals to be broadcast by speaker housing 10 are generally provided as electronic analog signals which may be carried to speaker housing by wiring or wirelessly utilizing connection 62. One of the wonderful advantages of the present invention is that it allows an installer to run a single cable as represented by 62 for the wired version. This is much easier than routing multiple cables to different parts of the room as is normally required for a surround sound system. The single cable will include speaker wires for every channel. For instance, for each surround sound channel, there may be at least two speaker wires within a shielded cable, wherein the shield of the cable is typically electrically grounded.

With the present invention, rather than having to run numerous wires over the entire room, it is only necessary to run one wiring harness, which includes all of the cables to the speaker housing 10. In one embodiment, a factory built connector may be provided on both ends of the cable so that all wiring may be easily connected. Within speaker housing 10, the wiring for each channel will preferably be factory installed with a connector on the outside of speaker housing, assuming a hardwired cable is utilized.

In another embodiment of the present invention, the need for running cables is completely eliminated by utilizing an electronic wireless transmitter as part of multiple channel sound system 74. Each channel may be broadcast in a different electronic channel or at a different electromagnetic frequency band or the like. Many different options are available, including spread spectrum techniques and the like. In one embodiment, Bluetooth technology standards may be used for transmitting electromagnetic signals of this type. For the wireless embodiment of the invention, multiple channel driver 66 may be mounted within speaker housing 10 and may comprise an analog signal amplifier and a wireless receiver. In this case, power may be supplied from power supply or power line 64. For that matter, the power line itself may comprise connection 62, wherein the multiple channels may be supplied to speaker housing 64 via the power line. With either the power line signal transmission or the electromagnetic wireless option, it is only necessary to run a power line to speaker housing 64. This is a very easy option as compared to running multiple lines to different parts of the room, or even supplying multiple power lines to multiple wireless speakers.

In one embodiment, it may be desirable to equalize or adjust the frequency response and channel directivity of the sound that reaches the center portion of the room where the listener may preferably be positioned. Equalizer 68 may be utilized for this purpose. Equalizer 68 could be manual and operated by a listener. For instance, a test signal covering the desired frequency range may be separately broadcast for each channel. Equalizer 68 can then be utilized to adjust the frequency response for the individual sound characteristics of the room. Equalizer 68 may also be utilized to adjust balance controls so that the amount of signal going to each speaker may be adjusted for best directivity of the system. For instance, in controlling the front center surround sound channel, it may be desirable to utilize not only speaker 12 but perhaps also some power from speakers 14 and 26 to provide the best directivity or sound that seems to come from the front. Other surround sound channels may also be adjusted accordingly.

In one possible embodiment, equalizer 68 may be computer-controlled using multidirectional acoustic sensors 70 and room acoustic module processor 72. In this embodiment, selected sounds may be automatically broadcast utilizing multiple channel sound system 74, wherein the direction, magnitude, and frequency range of these broadcast signals are detected with multidirectional acoustic signals sensor 70. Multidirectional acoustic sensor 70 may be of various types, as long as they are operational to determine the magnitude and/or frequency response and/or directivity of the acoustic output of the speakers. Multi-directional acoustic sensor 70 may be positioned at the listener position, which is usually the central part of the room. In this position, the acoustic sensors 70 may be utilized along with programmed controls for automatically setting up the acoustics of speaker housing 10 within any particular room. Thus, the time and effort required for adjustment of the surround sound system is greatly reduced. Other effects to be adjusted may include the phasing of the signal, although in relatively small rooms, this effect may often be ignored.

Accordingly, in operation, speaker housing 10 directs acoustic output in radial directions wherein each radial direction corresponds to a surround sound acoustic channel. This is shown graphically in FIG. 10 for a 5.1 channel surround sound system. The acoustic output reflects from the walls of the room whereupon it produces sound to the listener that appears to come from the area surrounding the listener. Speaker housing 10 is constructed to prevent acoustic output from the peripherally mounted speakers 12-26 from coming directly from these speakers. Other speakers, such as speaker 28, may be pointed directly to the listener. Therefore, the effect is a surround sound system that can be easily mounted, because most of the speakers are in a single speaker housing. It will be appreciated that because the speaker housing 10 may include any number of speakers, that even the most complicated surround sound system 10 can be easily implemented in accord with present invention. To the extent that wireless speakers are utilized, only one wireless receiver may be required that is capable of receiving the separate channels and routing those signals within speaker housing 10 to the correct speakers.

Accordingly, the foregoing disclosure and description of the invention is illustrative and explanatory thereof, and it will be appreciated by those skilled in the art, that various changes in the ordering of steps, ranges, hardware, software, and/or attributes and parameters, as well as in the details of the illustrations or combinations of features of the methods and system discussed herein, may be made without departing from the spirit of the invention.

What is claimed is:

1. A method for installing a standardized surround sound system within a room, the standardized surround sound system producing a plurality of channels of acoustic output, wherein each channel is representative of acoustic sound from a different direction for an anticipated listener, said plurality of channels comprising at least a front center channel, a front left side channel, a front right side channel, a rear left channel and a rear right channel, said method comprising:
mounting a speaker housing in a central position of said room, said speaker housing comprising a plurality of speakers mounted within said speaker housing wherein, respective of said plurality of speakers, produce said plurality of channels of acoustic output, said plurality of speakers being oriented such that an acoustic output therefrom is directed radially outwardly away from said housing and said central position of said room toward walls of said room, whereby acoustic output produced by said plurality of speakers originates at said central position of said room and reflects from said walls of said room back to said central position of said room, said speaker housing comprising speakers representative of said plurality of channels and comprising at least a front center speaker, a front left side speaker, a front right side speaker, a rear left speaker and a rear right speaker, said plurality of speakers each being less than about three inches in diameter, thereby permitting said speaker housing to be compact; and
after said mounting of said speaker housing, said front center speaker is oriented to direct acoustic output therefrom toward a front center position of said room, said front left side speaker being oriented to direct acoustic output therefrom toward said front left side of said room, said front right side speaker to direct acoustic output therefrom toward a front right side of said room, said rear left speaker being oriented to direct acoustic output therefrom toward a rear left of said room, and said rear right speaker being oriented to direct acoustic output therefrom towards a right rear of said room.

2. The method of claim 1, further comprising mounting said speaker housing to a ceiling, said speaker housing comprising at least one additional speaker at a lower portion thereof and oriented directly downwardly to said central position of said room.

3. The method of claim 2, wherein said speaker housing further comprises an acoustic insulator layer that dampens acoustic output in a downwardly direction when said speaker housing is mounted to said ceiling, said plurality of speakers being mounted adjacent to or at a periphery of speaker housing such that acoustic output from said speakers directed downwardly is dampened, said plurality of speakers being mounted inside an outer perimeter of said acoustic insulator layer whereby acoustic output produced by said plurality of speakers around said periphery must travel outward and reflect against walls of said room to reach said central position of said room, said acoustic insulator layer comprising at least one hole therein to receive said at least one additional speaker.

4. The method of claim 1, further comprising running a single wiring harness between an amplifier and said speaker housing, said single wiring harness comprising speaker wires for said plurality of speakers.

5. The method of claim 1, further comprising wirelessly transmitting surround sound channel signals for said plurality of speakers to an electronic wireless receiver positioned within said speaker housing, and speaker wires connecting said electronic wireless receiver to corresponding of each of said plurality of speakers.

6. The method of claim 2, further comprising providing ceiling lights within said speaker housing.

7. The method of claim 1, further comprising mounting said speaker housing within a table or on a stand.

8. The method of claim 1, further comprising a computer controlled acoustic equalizer to produce a desired acoustic response at said central position of said room by utilizing a directed acoustic sensor positioned at said central position whereby said directed acoustic sensor is operable for determining a strength and direction of acoustic signals produced by said speaker housing.

9. A speaker system to implement a standardized surround sound system for installation within a room, said room being defined by walls and a ceiling and floor, said room comprising a central position, said standardized surround sound system comprising a plurality of channels of acoustic output wherein each channel is representative of acoustic sound from a different direction for an anticipated listener, said plurality of channels comprising at least a front center channel, a front left side channel, a front right side channel, a rear left channel and a rear right channel said system comprising:
a speaker housing;
a plurality of speakers within said housing wherein respective of said plurality of speakers produce said plurality of channels of acoustic output, said speaker housing comprising at least a front center speaker, a front left side speaker, a front right side speaker, a rear left speaker and a rear right speaker, said plurality of speakers each being less than about three inches in diameter thereby permitting said speaker housing to be compact, said plurality of speakers being oriented such that when said speaker housing is mounted within said room, that acoustic output is directed radially away from said housing toward said walls of said room, and whereby when said speaker housing is mounted at a central position of said room, then acoustic output produced by said plurality of speakers originates at said central position of said room and reflects from said walls of said room back to said central position; and
at least one acoustic insulator layer, said at least one acoustic insulator layer being open at a radial periphery of said housing such that said acoustic output produced by said plurality of speakers directed radially outwardly is not dampened, but whereby acoustic output directed toward said at least one acoustic insulator layer is dampened.

10. The system of claim 9, further comprising said at least one acoustic insulator layer being positioned on a lower end of said speaker housing such that when said speaker housing is mounted to or adjacent to said ceiling, that said acoustic insulator layer dampens acoustic output traveling directly downwardly from said plurality of speakers toward said floor of said room.

11. The system of claim 10, wherein said acoustic insulator layer defines at least one hole therein to receive at least one additional speaker to permit acoustic output from said at least one additional speaker to go without hindrance directly toward said floor of said room.

12. The system of claim 9, further comprising an electronic speaker driver, a single wiring harness between said electronic speaker driver and said speaker housing, said single wiring harness comprising speaker wires for said plurality of speakers.

13. The system of claim 9, further comprising a wireless transmitter operable to electromagnetically transmit said plurality of channels of acoustic output, a wireless receiver being positioned within said speaker housing to electromagnetically receive said plurality of channels of acoustic output and to produce corresponding electrical signals for driving said plurality of speakers, and a plurality of speaker wires within said speaker housing connecting said wireless receiver to respective of said plurality of speakers.

14. The system of claim 9, further comprising said at least one acoustic insulator layer being positioned on an upper end of said speaker housing such that when said speaker housing is mounted adjacent to said floor, that said acoustic insulator layer dampens acoustic output traveling directly upwardly from said plurality of speakers toward said ceiling of said room.

15. The system of claim 14, wherein said acoustic insulator layer defines at least one hole therein to receive at least one additional speaker to permit acoustic output from said at least one additional speaker to transmit without hindrance directly toward said ceiling of said room.

16. The system of claim 15, wherein said acoustic speaker housing is built into a table.

17. The system of claim 9, wherein said acoustic speaker housing is positioned closely to said ceiling on a stand.

18. The system of claim 9, further comprising a directional acoustic sensor operable for determining acoustic signal strength and directions of said acoustic output from said speaker housing, and a computer controlled acoustic equalizer to produce a desired acoustic response at said central position of said room.

19. A speaker system to implement a standardized surround sound system for installation within a room, said room being defined by walls and a ceiling and floor, said room comprising a central position, said standardized surround sound system comprising a plurality of channels of acoustic output wherein each channel is representative of acoustic sound from a different direction for an anticipated listener, said plurality of channels comprising at least a front center channel, a front left side channel, a front right side channel, a rear left channel and a rear right channel, said system comprising:
a speaker housing;
a plurality of speakers within said housing wherein respective of said plurality of speakers produce said plurality of channels of acoustic output, a front left side speaker, a front right side speaker, a rear left speaker and a rear right speaker, said plurality of speakers each being less than about three inches in diameter, thereby permitting said speaker housing to be compact, said plurality of speakers being oriented such that when said speaker housing is mounted within said room, that acoustic output is directed radially away from said housing toward said walls of said room, and whereby when said speaker housing is mounted, then acoustic output produced by said plurality of speakers originates at said central position of said room and reflects from said walls of said room back to said central position; and
at least one acoustic insulator layer, said at least one acoustic insulator layer being open at a radial periphery of said housing such that said acoustic output produced by said plurality of speakers directed radially outwardly is not dampened, but whereby acoustic output directed toward said at least one acoustic insulator layer is dampened, said insulator layer being positioned on a lower end of said speaker housing such that when said speaker housing is mounted to or adjacent to said ceiling, that said acoustic insulator layer dampens acoustic output traveling directly downwardly from said plurality of speakers toward said floor of said room.

20. The system of claim 19, further comprising a wireless transmitter operable to electromagnetically transmit said plurality of channels of acoustic output, a wireless receiver being positioned within said speaker housing to electromagnetically receive said plurality of channels of acoustic output and to produce corresponding electrical signals for driving said plurality of speakers, and a plurality of speaker wires within said speaker housing connecting said wireless receiver to respective of said plurality of speakers.
